(19) United States
(12) Patent Application Publication
(10) Pub. No.: US 2026/0234467 A1
(43) Pub. Date: Aug. 13, 2026

(54) OPTICAL BRIGHTENERS IN MYOPIA CONTROL CONTACT LENSES

(71) Applicant: Alcon Inc., Fribourg (CH)

(72) Inventor: John Dallas Pruitt, Suwanee, GA (US)

(21) Appl. No.: 19/535,018

(22) Filed: Feb. 10, 2026

Related U.S. Application Data
(60) Provisional application No. 63/757,594, filed on Feb. 12, 2025.

(51) Int. Cl. C09K 11/02; C08G 77/20; C08K 5/00; C09K 11/06; G02B 1/04; G02C 7/04

(52) U.S. Cl. CPC C09K 11/02; C08G 77/20; C08K 5/0041; C09K 11/06; G02B 1/043; G02C 7/04; G02C 2202/24

(57) ABSTRACT

In general, embodiments of the present disclosure relate to contact lenses configured to prevent or slow the development of myopia in children. In particular, embodiments of the present disclosure relate to contact lenses that produce de-focused blue light. In at least some embodiments, a contact lens for treating myopia progression is provided. The contact lens includes a bulk silicone hydrogel material and a monomeric optical brightener disposed throughout the bulk silicone hydrogel material. The bulk silicone hydrogel material includes repeating units of at least one hydrophilic vinylic monomer and repeating units of at least one silicone-containing vinylic monomer, at least one polysiloxane vinylic crosslinker or combinations thereof.

### INTRODUCTION

Aspects of the present disclosure relate to the field of vision correction and, more specifically, to contact lenses configured to prevent or slow development of myopia.

### BACKGROUND

In children, a self-correcting mechanism adjusts the growth of the eye so that the light-sensitive retina is located where images of the visual world are focused (the focal plane), producing clearly focused vision (“emmetropia”). This mechanism uses visual cues to determine if the eye is too short (hyperopia) or has grown too long (myopia) relative to the focal plane and adjusts eye growth to move the retina back to emmetropia. However, this mechanism allows the eyes to become too long so the eyes are myopic (nearsighted). Myopia is particularly prevalent for people who spend much of their time indoors. High amounts of myopia raise the risks of developing retinal holes or tears, retinal detachment, choroidal degeneration, glaucoma, cataract, and other potentially blinding conditions caused by the elongated eye. Current treatments aimed at preventing or slowing the development of myopia have achieved modest success. For example, the economic cost of glasses, contact lenses, and refractive surgery is many millions of dollars in the U.S. alone, and these treatments thus far do not remove the risk of blindness because they do not alter the length of the eye. As a result, the affected eye remains elongated.

Myopia predominantly develops and progresses in childhood between the ages of 5 and 15. Because slowing myopia development may involve treatment throughout this extended period, such treatment should be safe for long-term, extended use. Many have therefore sought to develop effective ways to prevent children from developing myopia or to slow the rate of myopia development to reduce the final amount of myopia in adulthood. For example, low-dose atropine has been used as a pharmaceutical approach. However, in addition to the side effects of reducing the amplitude of accommodation and slight mydriasis, atropine dilates the pupil and increases higher order aberration and reduction of visual quality.

Optical approaches have also been attempted with refractive or light scattering optical approaches finding limited efficacy. In particular, the current refractive strategies for myopia control (e.g., ortho-keratology lenses, multisegment spectacle lenses, and dual focus design contact lenses) are based on a peripheral defocus theory. The theory states that hyperopic peripheral defocus can lead to myopic growth. As such, lenses which minimize or eliminate peripheral hyperopic defocus can prevent axial elongation. Attempts are made to change the peripheral defocus while also maintaining clear vision on the central retina. Such lenses use multifocal or non-coaxial designs to manipulate focus at the peripheral retina. Such lenses have a risk of hindering vision development for children who are undergoing the visual experience-dependent critical period of vision development for adulthood. For example, for the ortho-keratology lenses, the total higher order aberration increases after wearing the ortho-keratology lens, which reduces retinal image quality.

In addition, other attempted treatments such as prior studies related to narrow bandwidth light treatments (e.g., narrow bandwidth red light or blue light) of eyes have provided highly inconsistent results, depending on the species of animal tested and methods of treatment. In addition, the long-term effectiveness of such treatments is currently speculative. For example, a modest rebound effect has been observed upon cessation of low-level red light therapy. The same is true for cessation of pharmaceutical approaches, such as the prescription atropine treatments. In addition, for narrow bandwidth light treatment, the affected retinal region will vary with fixational eye movements during the treatment.

An effective, safe, non-invasive, non-pharmacological treatment that could be used with ease in the course of daily life over many years would be of benefit to millions of people. Accordingly, there is a need for non-invasive methods to promote emmetropization and prevent or slow the development of myopia, for example, in the developing eyes of children.

### BRIEF SUMMARY

Embodiments described herein generally relate to contact lenses configured to prevent or slow development of myopia. In particular, embodiments of the present disclosure relate to contact lenses that produce de-focused blue light.

Some embodiments provide a contact lens for treating myopia progression. The contact lens includes a bulk silicone hydrogel material and a monomeric optical brightener disposed throughout the bulk silicone hydrogel material. The bulk silicone hydrogel material includes repeating units of at least one hydrophilic vinylic monomer and repeating units of at least one silicone-containing vinylic monomer, at least one polysiloxane vinylic crosslinker or combinations thereof.

Some embodiments provide an anti-myopiagenic contact lens. The anti-myopiagenic contact lens includes a bulk silicone hydrogel material, a monomeric optical brightener disposed substantially throughout the bulk silicone hydrogel material, and a light absorbing chromophore disposed over an anterior surface of the bulk silicone hydrogel material. The monomeric optical brightener selected from the group consisting of a stilbene, an oxazole, and combinations thereof.

Some embodiments provide a contact lens including a bulk silicone hydrogel material, a monomeric optical brightener disposed on a posterior surface of the bulk silicone hydrogel material, and a light absorbing chromophore disposed over an anterior surface of the bulk silicone hydrogel material. The bulk silicone hydrogel material includes repeating units of at least one hydrophilic vinylic monomer, and repeating units of at least one silicone-containing vinylic monomer, at least one polysiloxane vinylic crosslinker or combinations thereof.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 depicts a peripheral view of a contact lens, in accordance with some embodiments described herein.

FIG. 2 depicts a peripheral view of a coated contact lens, in accordance with some embodiments described herein.

FIG. 3 depicts a peripheral view of an alternate coated contact lens, in accordance with some embodiments described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

In general, embodiments of the present disclosure relate to contact lenses configured to prevent or slow the development of myopia in children. In particular, embodiments of the present disclosure relate to contact lenses that produce de-focused blue light. For example, embodiments of the present disclosure relate to a silicone hydrogel based contact lens having an optical brightener disposed throughout the contact lens. When exposed to ultraviolet (UV) or violet light, the optical brightener fluoresces blue light, creating a large intensity influx of blue light and achieving a de-focused blue light effect with little or no reduction in contrast for red and green light. The de-focused blue light creates a large difference in focal distance and overall signal between the green and red cones and the cones responsible for blue light, stunting lens growth signaling and thus preventing development of myopia in children. In at least some embodiments, the optical brightener is a monomeric optical brightener suspended in and through the polymer matrix that forms the contact lens. In other embodiments, the optical brightener is printed as a layer on one side (e.g., the posterior side) of the contact lens.

Reference will now be made in detail to the embodiments of the disclosure. It will be apparent to those skilled in the art that various modifications, variations and combinations can be made in the present disclosure without departing from the scope or spirit of the disclosure. For instance, features illustrated or described as part of one embodiment, can be used on another embodiment to yield still further embodiments. Thus, it is intended that the present disclosure cover such modifications, variations and combinations as come within the scope of the appended claims and their equivalents. Other objects, features and aspects of the present disclosure are disclosed in or are obvious from the following detailed description. It is to be understood by one of ordinary skill in the art that the present discussion is a description of exemplary embodiments only, and is not intended as limiting the broader aspects of the present disclosure.

Unless defined otherwise, all technical and scientific terms used herein have the same meaning as commonly understood by one of ordinary skill in the art to which this disclosure belongs. Generally, the nomenclature used herein and the laboratory procedures are well known and commonly employed in the art. Conventional methods are used for these procedures, such as those provided in the art and various general references. Where a term is provided in the singular, the disclosure also contemplates the plural of that term. The nomenclature used herein and the laboratory procedures described below are those known and commonly employed in the art.

“Optional” or “optionally” means that the subsequently described event or circumstance can or cannot occur, and that the description includes instances where the event or circumstance occurs and instances where it does not.

As used in this application, the term “contact lens” refers to an object that can be placed on or within a wearer's eye. A contact lens can correct, improve, or alter a user's eyesight, but that need not be the case. A contact lens can be of any appropriate material known in the art or later developed, and can be a soft lens, a hard lens, or a hybrid lens.

The “anterior surface” of a contact lens, as used herein, refers to the surface of the lens that faces away from the eye during wear. The anterior surface, which is typically substantially convex, may also be referred to as the front curve of the lens.

The “posterior surface” of a contact lens, as used herein, refers to the surface of the lens that faces towards the eye during wear. The posterior surface, which is typically substantially concave, may also be referred to as the base curve of the lens.

As used in this application, the term “silicone hydrogel contact lens” refers to a contact lens comprising a silicone hydrogel material.

A siloxane, which often also described as a silicone, refers to a molecule having at least one moiety of —Si—O—Si— where each Si atom carries two organic groups as substituents.

A “hydrogel” or “hydrogel material” refers to a crosslinked polymeric material which has three-dimensional polymer networks (i.e., polymer matrix), is insoluble in water, but can hold at least 10% by weight of water in its polymer matrix when the material is fully hydrated (or equilibrated).

A “silicone hydrogel” or “SiHy” refers to a silicone-containing hydrogel obtained by copolymerization of a polymerizable composition comprising at least one silicone-containing monomer or at least one silicone-containing macromer or at least one crosslinkable silicone containing prepolymer.

“Hydrophilic,” as used herein, describes a material or portion thereof that will more readily associate with water than with lipids.

The term “soluble”, in reference to a compound or material in a solvent, means that the compound or material can be dissolved in the solvent to give a solution with a concentration of at least about 0.5% by weight at room temperature (e.g., from about 22° C. to about 26° C.).

The term “insoluble”, in reference to a compound or material in a solvent, means that the compound or material can be dissolved in the solvent to give a solution with a concentration of less than 0.01% by weight at room temperature (as defined above).

A “vinylic monomer” refers to a compound that has one sole ethylenically unsaturated group, is soluble in a solvent, and can be polymerized actinically or thermally.

As used in this application, the term “ethylenically unsaturated group” is employed herein in a broad sense and is intended to encompass any groups containing at least one >C═C< group. Some example ethylenically unsaturated groups include (meth)acryloyl

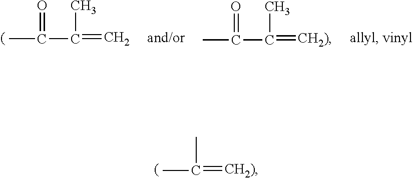

styrenyl, or other C═C containing groups.

An “acrylic monomer” refers to a vinylic monomer having one sole (meth)acryloyl group. Examples of acrylic monomers includes (meth)acryloxy [or(meth)acryloyloxy]monomers and (meth)acrylamido monomers.

As used in this application, the term “(meth)acrylamide” refers to methacrylamide and/or acrylamide.

As used in this application, the term “(meth)acrylate” refers to methacrylate and/or acrylate.

As used herein, “actinically” in reference to curing, crosslinking or polymerizing of a polymerizable composition, a prepolymer or a material means that the curing (e.g., crosslinked and/or polymerized) is performed by actinic irradiation, e.g., UV/visible light irradiation, or the like.

A “vinyloxycarbonylamino monomer” refers to a vinylic monomer having one sole vinyloxycarbonylamino group.

A “vinylaminocarbonyloxy monomer” refers to a vinylic monomer having one sole vinylaminocarbonyloxy group.

A “vinylaminocarbonylamino monomer” refers to a vinylic monomer having one sole vinylaminocarbonylamino group.

As used in this application, the term “hydrophilic vinylic monomer” refers to a vinylic monomer, which as a homopolymer typically yields a polymer that is water-soluble or can absorb at least 10 percent by weight water.

As used in this application, the term “hydrophobic vinylic monomer” refers to a vinylic monomer which as a homopolymer typically yields a polymer that is insoluble in water and can absorb less than 10 percent by weight water.

The term “terminal (meth)acryloyl group” refers to one (meth)acryloyl group at one of the two ends of the main chain (or backbone) of an organic compound.

As used in this application, the term “polymer” means a material formed by polymerizing and/or crosslinking one or more monomers, macromers, prepolymers or combinations thereof.

A “macromer” or “prepolymer” refers to a compound or polymer that contains ethylenically unsaturated groups and has a number average molecular weight of >700 Daltons.

As used in this application, the term “molecular weight” of a polymeric material (including monomeric or macromeric materials) refers to the number-average molecular weight unless otherwise specifically noted or unless testing conditions indicate otherwise. A skilled person knows how to determine the molecular weight of a polymer according to known methods, e.g., GPC (gel permeation chromatography) with one or more of a refractive index detector, a low-angle laser light scattering detector, a multi-angle laser light scattering detector, a differential viscometry detector, a UV detector, and an infrared (IR) detector; MALDI-TOF MS (matrixassisted laser desorption/ionization time-of-flight mass spectroscopy); 1H NMR (Proton nuclear magnetic resonance) spectroscopy, etc.

A “polysiloxane segment” or “polydiorganosiloxane segment” interchangeably refers to a polymer chain segment (i.e., a divalent radical) of

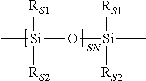

in which SN is an integer of 3 or larger and each of R_{S1} and R_{S2} independent of one another are C₁-C₁₀ alkyl; phenyl; C₁-C₄-alkyl-substituted phenyl; C₁-C₄-alkoxy-substituted phenyl; phenyl-C₁-C₆-alkyl; C₁-C₁₀ fluoroalkyl; C₁-C₁₀ fluoroether; aryl; aryl C₁-C₁₅ alkyl; -alk-(OC₂H₄)_{γ1}—OR^{o} (in which alk is C₁-C₆ alkylene diradical, R^{o} is H or C₁-C₄ alkyl and 71 is an integer from 1 to 10); a C₂-C₄₀ organic radical having at least one functional group selected from the group consisting of hydroxyl group (—OH), carboxyl group (—COOH), amino group (—NR_{N1}RN_{1′}), amino linkages of —NR_{N1}—, amide linkages of —CONR_{N1}—, amide of —CONR_{N1}RN₁′, urethane linkages of —OCONH—, and C₁-C₄ alkoxy group, or a linear hydrophilic polymer chain, in which R_{N1} and R_{N1′} independent of each other are hydrogen or a C₁-C₁₅ alkyl; or a photochromic organic radical having a photochromic group.

The term “fluid” as used herein indicates that a material is capable of flowing like a liquid.

As used in this application, the term “photoinitiator” refers to a chemical that initiates radical crosslinking/polymerizing reaction by the use of light. Suitable photoinitiators include benzoin methyl ether, diethoxyacetophenone, a benzoylphosphine oxide, 1-hydroxycyclohexyl phenyl ketone, Darocure® types, and Irgacure® types, such as Darocure® 1173, and Irgacure® 2959.

As used in this application, the term “thermal free-radical initiator” refers to a chemical that initiates radical crosslinking/polymerizing reaction by the use of heat energy. Examples of suitable thermal initiators include 2,2′-azobis(2,4-dimethylpentanenitrile), 2,2′-azobis(2-methylpropanenitrile), 2,2′-azobis(2-methylbutanenitrle), peroxides such as benzoyl peroxide, and the like. For example, the thermal initiator is 2,2′-azobis(isobutyronitrile) (AIBN).

In this application, the term “substituted” in reference to an alkyl or an alkylenyl means that the alkyl or the alkylenyl comprises at least one substituent which replaces one hydrogen atom of the alkyl or the alkylenyl and may be selected from the group consisting of hydroxyl (—OH), carboxyl (—COOH), —NH₂, sulfhydryl (—SH), C₁-C₄ alkyl, C₁-C₄ alkoxy, C₁-C₄ alkylthio (alkyl sulfide), C₁-C₄ acylamino, C₁-C₄ alkylamino, di-C₁-C₄ alkylamino, and combinations thereof.

A “UV-absorbing vinylic monomer” refers to a compound comprising one sole ethylenically-unsaturated group and can absorb predominantly UV lights between 280 nm to 380 nm. It is understood that a UV-absorbing vinylic monomer does not absorb or absorbs negligibly lights having a wavelength greater 400 nm (i.e., having a % T at 400 nm of greater than 90% when tested with a solution of the UV-absorbing vinylic monomer at a concentration of 0.1 mM and a path length of 1 cm).

A “HEVL-absorbing compound” refers to a compound comprising one sole ethylenically-unsaturated group and can absorb high-energy visible lights (HEVL) between 380 nm and 450 nm. It is understood that a HEVL-absorbing compound can also absorb UV lights between 280 nm and 380 nm.

The term “high contrast” in reference to a signal or light means the activation level of adjacent cones in the eye of the viewer is different, for example, one cone is active and the adjacent cone is inactive, providing a sharp or focused signal or light.

The term “low contrast,” in reference to a signal or light means the activation level of adjacent cones in the eye of the viewer is similar, providing a blurry or de-focused signal or light.

A “coating” in reference to a contact lens means that the contact lens has, on the surfaces, a thin layer of a material that is different from the bulk material of the contact lens and obtained by subjecting the contact lens to a surface treatment.

“Surface treatment”, as used herein, means that an article has been treated in a surface treatment process, in which (1) a coating is applied to the surface of the article, (2) chemical species are adsorbed onto the surface of the article, (3) the chemical nature (e.g., electrostatic charge) of chemical groups on the surface of the article are altered, or (4) the surface properties of the article are otherwise modified. Surface treatment processes include a surface treatment by energy (e.g., a plasma, a static electrical charge, irradiation, or other energy source), chemical treatments, the grafting of hydrophilic vinylic monomers or macromers onto the surface of an article, mold-transfer coating process, the incorporation of wetting agents into a lens formulation for making contact lenses, reinforced mold-transfer coating, and a hydrophilic coating composed of covalent attachment or physical deposition of one or more layers of one or more hydrophilic polymer onto the surface of a contact lens.

In general, embodiments of the present disclosure relate to contact lenses configured to prevent or slow myopia, for example, in children. In particular, embodiments of the present disclosure relate to contact lenses that produce de-focused blue light. For example, embodiments of the present disclosure relate to a silicone hydrogel based contact lens having an optical brightener disposed throughout the contact lens. When exposed to ultraviolet (UV) or violet light, the optical brightener fluoresces blue light creating a large intensity influx of blue light to the retina. In doing so, the overall contrast of the blue light can be significantly reduced with little or no reduction in contrast for red and green light.

Without being bound by theory, light is detected by the eye because light is absorbed by the photopigments of the cones, the sensory cells in the retina. There are two types of cones in most mammals, the short-wavelength sensitive (SWS) cones that preferentially absorb and detect blue light, and the long-wavelength sensitive (LWS) cones that preferentially detect red light. Both types of cones are present across the retina. In addition, most humans have a third middle-wavelength sensitive (MWS) cone photopigment. Middle-wavelength includes green light. The peak of the MWS absorbance is close to that of the LWS photopigment and the profile of the MWS photopigment overlaps extensively with that of the LWS cones. Dichromatic humans that, like the tree shrew, only have two photopigments, emmetropize normally. Without being bound by theory, it is believed that the peripheral retina drives myopia progression. When there are competing visual signals in the central versus the peripheral retina, experiments in chicks, marmosets, and macaques have demonstrated that peripheral signals can dominate axial ocular growth and central refractive development. If SWS cone array of the retina detects sharper images on the retina than the LWS system, post-receptor retinal circuitry then signals for increased axial growth (a positive drive). The imbalance between SWS and LWS image statistics directs eye growth toward the point at which this image contrast is in balance. Therefore, a contact lens allowing a large amount of reduced contrast blue light toward the retina can provide an imbalance of SWS to LWS image statistics such that the eye growth is directed toward a maintained or decreased axial growth (a negative drive). Preferentially reducing the blue contrast can also provide superior visual quality versus reduction in contrast overall.

In at least some embodiments, the contact lenses of the present disclosure provide low contrast blue light evenly toward the central retina and peripheral retina with little or no reduction in contrast for red and green light. Such contact lenses provide distinct advantages over contact lenses having a large plurality of peripheral zones providing dual focus lenses. Unlike prior contact lenses, use of a myopic defocus mechanism (dual focus) for lenses of the present disclosure is not required and has been rendered merely optional. In addition, lenses of the present disclosure that are dual focus can have zones having a larger dioptric power difference without adversely affecting vision quality (e.g., central zone of 0 dioptric power and peripheral zone of >3) while still providing anti-myopiagenic benefits, unlike prior anti-myopiagenic dual focus contact lenses.

Anti-myopiagenic benefits can include slowing or preventing axial growth of an eye of children and young adults. In addition, unlike narrow bandwidth light treatments, contact lenses can be worn during everyday life and anti-myopia treatment occurs during this time. Such continuous treatment by allowing blue light at the retinal periphery also negates the fixational eye movement restraints of narrow bandwidth light treatments.

The emmetropization mechanism evolved and normally operates in broadband (“white”) light where all wavelengths are present across the visible spectrum (400-700 nm). In broadband light, many cues are present in a defocused image that potentially can provide the drive that generates retinal signals used to modulate axial elongation. For example, in a defocused eye, image contrast on the retina is reduced. The retinal image produced by a sharp light-dark edge becomes a more gradual change from higher to lower illuminance across the retina. Other cues, such as high spatial frequencies, higher order-aberrations (astigmatism, coma, etc.) and other possible cues are also altered. The specific optical cues used by the emmetropization mechanism share the basic premise that the retina doesn't specifically detect “defocus”; rather the retina detects changes in the “image statistics” (such as image contrast) across the retinal surface that are produced by defocus.

Contact lenses of the present disclosure provide low (or reduced) contrast blue light across the retina relative to the red and green light permitted across the retina. It is believed such embodiments may be interpreted by the retina as the eye having too long of an axial length, indicating that the eye should stop growing (anti-myopiagenic). Accordingly, use of the above mentioned defocus mechanism is merely optional.

In some embodiments, as referenced herein, the shorter wavelength (blue light) is somewhere in the range of green to blue. In further embodiments, the shorter wavelength is 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, 390 nm, 380 nm, up to any of the foregoing values, or a range between any two of the foregoing values. In further embodiments, the longer wavelength (red light) is somewhere in the range of green to red. In further embodiments, the longer wavelength is 560 nm, 570 nm, 580 nm, 590 nm, 600 nm, 610 nm, 630 nm, 640 nm, 650 nm, 660 nm, 670 nm, 680 nm, 690 nm, 700 nm, 710 nm, 720 nm, 730 nm, 740 nm, at least any of the foregoing values, or a range between any two of the foregoing values.

In some embodiments, whether the optical brightener is disposed throughout the lens material and/or disposed onto a lens as a layer, the optical brightener can be present in the overall lens in an amount of about 2 wt % or less, such as about 0.01 wt % to about 1.5 wt %, such as about 0.05 wt % to about 1 wt %, such as about 0.1 wt % to about 1 wt %, such as about 0.01 wt % to about 0.1 wt %, alternatively about 0.1 wt % to about 0.2 wt %, alternatively about 0.2 wt % to about 0.3 wt %, alternatively about 0.3 wt % to about 0.4 wt %, alternatively about 0.4 wt % to about 0.5 wt %, alternatively about 0.5 wt % to about 0.6 wt %, alternatively about 0.6 wt % to about 0.7 wt %, alternatively about 0.7 wt % to about 0.8 wt %, alternatively 0.8 wt % to about 0.9 wt %, alternatively about 0.9 wt % to about 1 wt %.

### Contact Lenses

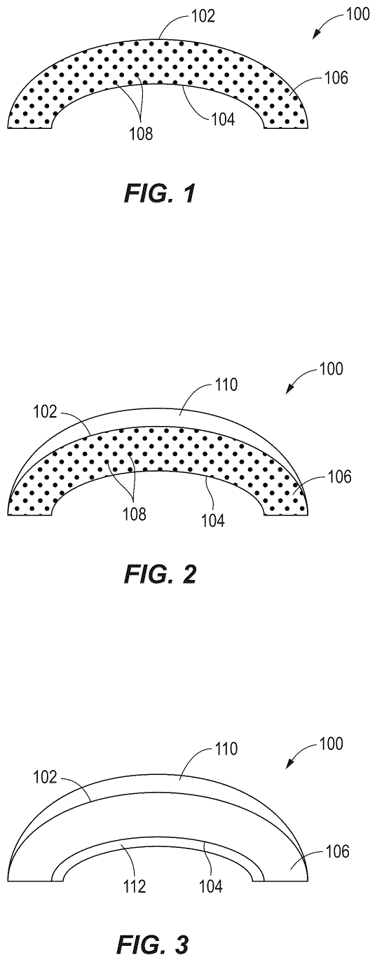

FIG. 1 depicts a contact lens, according to some embodiments. In accordance with some embodiments, the contact lens 100 has an anterior surface (or front curve or convex surface) 102 and an opposite posterior surface (or base curve or concave surface) 104 which rests on the cornea of the eye when worn by a user. The contact lens 100 includes a bulk silicone hydrogel material 106 and a monomeric optical brightener 108. The bulk silicone hydrogel material 106 is the bulk material of the contact lens 100 and has a 3-dimensional shape close to final shape of the contact lens 100. In at least some embodiments, the monomeric optical brightener 108 is disposed throughout at least a substantial portion of the bulk silicone hydrogel material 106. In at least some embodiments, the monomeric optical brightener 108 is substantially evenly distributed between an anterior surface 102 of the contact lens 100 and a posterior surface 104 of the contact lens 100. In other embodiments, the monomeric optical brightener 108 may be disposed in certain portions of the bulk silicone hydrogel material 106. For example, the monomeric optical brightener 108 may be concentrated at or near the posterior surface 104 of the contact lens 100, at or near the anterior surface 102 of the contact lens 100, at or near the middle of the contact lens 100, or combinations thereof.

An “optical brightener” generally refers to compounds that absorb ultraviolet light and reemit light in the blue region via fluorescence. Upon exposure to UV light, the monomeric optical brightener 108 disposed throughout the bulk silicone hydrogel material 106 emits blue light in all directions, achieving a de-focused blue light effect. In at least some embodiments, the blue light fluoresced by the monomeric optical brightener 108 is low contrast blue light. The monomeric optical brightener 108 creates a large intensity influx of blue light, lowering the contrast of the blue light observed by the retina of the user with little or no reduction in contrast for red and green light. In at least some embodiments, the monomeric optical brightener 108, absorbs light in the ultraviolet light region and violet light region having a wavelength of about 340 nm to about 420 nm and re-emits light in the blue light region having a wavelength of about 420 nm to about 470 nm.

In at least some embodiments, the monomeric optical brightener 108 is present in any amount that produces a measurable amount of low contrast blue light in the contact lens 100 without quenching the fluorescence of the monomeric optical brightener 108. At high concentrations fluorescent compounds, such as the monomeric optical brightener 108, may undergo a self-quenching, where the intensity of the fluorescence of each monomeric optical brightener 108 is significantly reduced due to the molecular interactions of other monomeric optical brighteners 108 in close proximity.

In at least some embodiments, the monomeric optical brightener 108 is an unreactive optical brightener, e.g. a monomeric optical brightener that is not polymerized and not incorporated into the polymer(s) that forms the bulk silicone hydrogel material 106. The monomeric optical brightener 108 may be a monomer suspended in the polymer matrix of the bulk silicone hydrogel material 106 that forms the contact lens 100. In at least some embodiments, the monomeric optical brightener 108 is a stilbene, an oxazole, or combinations thereof. Suitable optical brighteners are bis(benzoxazol-2-yl) derivatives, distyrylbenzenes, distyrylbiphenyls, divinylstilbenes, triazinylaminostilbenes, stilbenyl-2H-triazoles, benzofurans, benzimidazoles, diphenyl pyrazolines, coumarins, naphthalimides, and the likes. Examples of optical brighteners include 4,4′-diamino-2,2′-stilbenedisulfonic acid, 2,2′-(1,4-naphthalenediyl)bisbenzoxazole, 2,5-thiophenediylbis(5-tert-butyl-1,3-benzoxazole), 4,4′-bis(2-benzoxazolyl)stilbene, disodium-4,4′-bis(2-sulfonatostyryl)biphenyl, and combinations thereof. In at least some embodiments, the monomeric optical brightener 108 includes 2,5-thiophenediylbis(5-tert-butyl-1,3-benzoxazole), 4 4′-bis(2-benzoxazolyl)stilbene, disodium-4,4′-bis(2-sulfonatostyryl)biphenyl, or combinations thereof.

In at least some embodiments, a light absorbing chromophore 110 is disposed over the bulk silicone hydrogel material 106 on the anterior surface 102 of the contact lens 100, as depicted in FIG. 2. In at least some embodiments, the light absorbing chromophore may be a blue light absorbing chromophore that absorbs light having a wavelength centered near 450 nm, such as a wavelength of about 420 nm to about 460 nm, and transmits light having a wavelength of about 370 nm to about 420 nm, such as about 380 nm to about 420 nm. The light absorbing chromophore may block extreme UV light (120 nm-320 nm) while allowing UV light having a wavelength of about 380 nm to about 420 nm to pass through to activate the monomeric optical brightener 108. The blue light fluoresced by the monomeric optical brightener 108 may be transmitted in the posterior direction towards the eye, while outward anterior transmission of blue light is blocked by the light absorbing chromophore, providing a more aesthetically pleasing contact lens. For example, the outward transmission of the fluoresced blue light may give the contact lens 100 a glowing appearance, which is advantageously blocked by the light absorbing chromophore 110 disposed over the anterior surface 102 of the contact lens 100. In addition, the light absorbing chromophore may reduce the amount of high contrast blue light entering the eye from the environment thereby increasing the relative ratio of low contrast blue light produced by the fluorescent chromophore. In at least some embodiments, the light absorbing chromophore 110 is a high-energy visible light (HEVL) absorbing chromophore.

FIG. 3 depicts a peripheral view of an alternate coated contact lens, in accordance with some embodiments described herein. In at least some embodiments, the monomeric optical brightener 108 is disposed on the posterior surface 104 of the bulk silicone hydrogel material 106 as an optical brightener layer 112. In at least some embodiments, the optical brightener layer 112 is disposed within an optic zone of the contact lens. The optic zone includes the portion of the contact lens 100 that, when worn by a user, is disposed over the pupil and iris of the eye. In such embodiments, the positioning of the optical brightener layer 112 provides aesthetic advantages, as only the optical zone of the contact lens 100 may appear to glow when the monomeric optical brightener 108 is active. The thickness of a layer 112/110 can depend on the concentration of optical brightener used in the layer. In some embodiments, layers 112 and/or 110 independently have a thickness of about 1 micron to about 100 microns, such as about 10 microns to about 80 microns, such as about 10 microns to about 20 microns, alternatively about 20 microns to about 30 microns, alternatively about 40 microns to about 50 microns, alternatively about 50 microns to about 60 microns, alternatively about 60 microns to about 70 microns, alternatively about 70 microns to about 80 microns. In some embodiments, a relatively thick pad printing layer as a layer 112/110 can be utilized and optical brightener concentration may be high.

In accordance with the disclosure, the bulk silicone hydrogel material 106 of the contact lens 100 may be referred to as the bulk material or bulk layer of the lens. In at least some embodiments, the bulk silicone hydrogel material 106 generally includes repeating units of at least one hydrophilic vinylic monomer and repeating units of at least one silicone-containing vinylic monomer and/or at least one polysiloxane vinylic crosslinker. In at least some embodiments, the bulk silicone hydrogel material 106 may also include one or more other components, such as, repeating units of at least one UV-absorbing vinylic monomer, repeating units of at least one polymerizable HEVL-absorbing compound, at least one visibility tinting agent (e.g., dyes, pigments, or mixtures thereof), such as a blue-tinting agent distributed within the bulk silicone hydrogel material 106, at least one free-radical initiator, at least one hydrophobic non-silicone vinylic monomer, at least one non-silicone vinylic crosslinker, a leachable lubricant, a leachable tear-stabilizing agent, or combinations thereof.

Any hydrophilic vinylic monomers can be used in the formulation of the bulk silicone hydrogel material 106. A number of hydrophilic vinylic monomers have been commonly used in combination with other polymerizable components in making hydrogel contact lenses. Examples of hydrophilic vinylic monomers include hydroxyethyl (meth)acrylate, glycerol (meth)acrylate, N-2-hydroxylethyl (meth)acrylamide, N,N-bis(hydroxyethyl) (meth)acrylamide, N-3-hydroxypropyl(meth)acrylamide, N-2-hydroxypropyl (meth)acrylamide, N-2,3-dihydroxypropyl(meth)acrylamide, di(ethylene glycol) (meth)acrylate, tri(ethylene glycol) (meth)acrylate, tetra(ethylene glycol) (meth)acrylate, poly(ethylene glycol) (meth)acrylate, N,N-dimethyl(meth)acrylamide, (meth)acrylamide, N-ethyl (meth)acrylamide, N,N-diethyl (meth)acrylamide, N-propyl (meth)acrylamide, N-isopropyl (meth)acrylamide, N-3-methoxy-propyl(meth)acrylamide, N-vinylpyrrolidone, N-vinyl-N-methyl acetamide, N-vinyl-N-ethyl acetamide, N-vinyl-N-ethyl formamide, 1-methyl-3-methylene-2-pyrrolidone, 1-methyl-5-methylene-2-pyrrolidone, 1-methyl-3-methylene-2-pyrrolidone, N-2-hydroxyethyl vinyl carbamate, Ncarboxyvinyl-β-alanine (VINAL), N-carboxyvinyl-α-alanine, a phosphorylcholine-containing vinylic monomer, (meth)acrylic acid, vinyl alcohol, ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, poly(ethylene glycol) methyl ether, and combinations thereof.

Examples of phosphorylcholine-containing vinylic monomers include (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]ethyl-2′-(trimethylammonio)-ethylphosphate, 3-[(meth)acryloylamino]-propyl-2′-(trimethylammonio)-ethylphosphate, 4-[(meth)acryloylamino]butyl-2′-(trimethyl-ammonio)ethylphosphate, 5-((meth)acryloyloxy)pentyl-2′-(trimethylammonio)ethyl phosphate, 6-((meth)acryloyloxy)hexyl-2′-(trimethylammonio)-ethylphosphate, 2-((meth)acryloyloxy)ethyl-2′-(triethylammonio)-ethylphosphate, 2-((meth)acryloyloxy)ethyl-2′-(tripropylammonio)ethyl-phosphate, 2-((meth)acryloyloxy)ethyl-2′-(tributylammonio)ethyl phosphate, 2-((meth)acryloxy)-propyl-2′-(trimethylammonio)-ethylphosphate, 2-((meth)acryloyloxy)butyl-2′-(trimethylammonio)-ethylphosphate, 2-((meth)acryloyloxy)pentyl-2′-(trimethylammonio)ethylphosphate, 2-((meth)acryloxy)hexyl-2′-(trimethylammonio)ethyl phosphate, 2-(vinyloxy)ethyl-2′-(trimethylammonio)ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2′-(trimethylammonio)ethylphosphate, 2-(vinylcarbonyl-amino)ethyl-2′-(trimethylammonio)-ethylphosphate, 2-(allyloxycarbonylamino)ethyl-2′-(trimethylammonio)ethyl phosphate, 2-(butenoyloxy)ethyl-2′-(trimethylammonio)-ethylphosphate, and combinations thereof.

Any siloxane-containing vinylic monomer can be used in the formulation of the bulk silicone hydrogel material 106. Examples of siloxane-containing vinylic monomers can be siloxane-containing (meth)acrylamide monomers, siloxane-containing (meth)acryloxy monomers, siloxane-containing vinyloxycarbonyloxy monomers, siloxane-containing vinyloxycarbonylamino monomers, siloxane containing vinylaminocarbonylamino monomers, or siloxane-containing vinylaminocarbonyloxy monomers, each of which includes a bis(trialkylsilyloxy)alkylsilyl group, a tris(trialkylsilyloxy)-silyl group, or a polysiloxane chain having 2 to 30 siloxane units and terminated with a C₁-C₆-alkyl, C₁-C₆-hydroxyalkyl or methoxy-C₁-C₆-alkyl group. Such siloxane-containing vinylic monomers can be obtained from the commercial suppliers, or alternatively prepared according to known procedures, or by reacting a vinylic monomer having a reactive functional group (e.g., an acid chloride, acid anhydride, carboxyl, hydroxyl, amino, epoxy, isocyanate, aziridine, azlactone, aldehyde group, or combinations thereof) with a siloxane-containing compound having a reactive group such as a hydroxyalkyl, an aminoalkyl, an alkylaminoalkyl, a carboxyalkyl, an isocyanatoalkyl, an epoxyalkyl, an aziridinylalkyl, and combinations thereof in the presence or absence of a coupling agent under coupling reaction conditions.

Examples of siloxane-containing vinylic monomers include tris(trimethylsilyloxy)silylpropyl (meth)acrylate, [3-(meth)acryloxy-2-hydroxypropyloxy]propylbis(trimethylsiloxy)methylsilane, [3-(meth)acryloxy-2-hydroxypropyloxy]propylbis(trimethylsiloxy)butylsilane, 3-(meth)acryloxy-2-(2-hydroxyethoxy)-propyloxy)propylbis(trimethylsiloxy)methylsilane, 3-(meth)acryloxy-2-hydroxypropyloxy)propyltris(trimethylsiloxy)silane, N-[tris(trimethylsiloxy)-silylpropyl]-(meth)acrylamide, N-(2-hydroxy-3-(3-(bis(trimethylsilyloxy)methylsilyl)-propyloxy)propyl)-2-methyl (meth)acrylamide, N-(2-hydroxy-3-(3-(bis(trimethylsilyloxy)-methylsilyl)propyloxy)-propyl) (meth)acrylamide, N-(2-hydroxy-3-(3-(tris(trimethylsilyloxy)-silyl)propyloxy)propyl)-2-methyl acrylamide, N-(2-hydroxy-3-(3-(tris(trimethylsilyloxy)silyl)-propyloxy)propyl) (meth)acrylamide, N-[tris(dimethylpropylsiloxy)-silylpropyl]-(meth)acrylamide, N-[tris(dimethylphenylsiloxy)-silylpropyl](meth)acrylamide, N-[tris(dimethylethylsiloxy)-silylpropyl](meth)acrylamide, N,N-bis[2-hydroxy-3-(3-(bis(trimethylsilyloxy)methylsilyl)-propyloxy)propyl]-2-methyl (meth)acrylamide, N,N-bis[2-hydroxy-3-(3-(bis(trimethylsilyloxy)methylsilyl)propyloxy)-propyl](meth)acrylamide, N,N-bis[2-hydroxy-3-(3-(tris(trimethylsilyloxy)silyl)propyloxy)-propyl]-2-methyl (meth)acrylamide, N,N-bis[2-hydroxy-3-(3-(tris(trimethylsilyloxy)silyl)-propyloxy)propyl](meth)acrylamide, N-[2-hydroxy-3-(3-(t-butyldimethylsilyl)propyloxy)-propyl]-2-methyl (meth)acrylamide, N-[2-hydroxy-3-(3-(tbutyldimethylsilyl)propyloxy)-propyl](meth)acrylamide, N,N-bis[2-hydroxy-3-(3-(tbutyldimethylsilyl)propyloxy)propyl]-2-methyl (meth)acrylamide, N-2-(meth)acryloxyethyl-O-(methyl-bis-trimethylsiloxy-3-propyl)silyl carbamate, 3-(trimethylsilyl)propylvinyl carbonate, 3-(vinyloxycarbonylthio)-propyl-tris(trimethyl-siloxy)silane, 3-[tris(trimethylsiloxy)silyl]-propylvinyl carbamate, 3-[tris(trimethylsiloxy)silyl]propyl allyl carbamate, 3-[tris(trimethylsiloxy)silyl]propyl vinyl carbonate, or a combination thereof.

Examples of polysiloxane vinylic monomers include mono-(meth)acryloyl-terminated, monoalkyl-terminated polysiloxanes such as α-(meth)acryloxypropyl terminated ω-butyl (or ω-methyl) terminated polydimethylsiloxane, α-(meth)acryloxy-2-hydroxypropyloxypropyl terminated ω-butyl (or ω-methyl) terminated polydimethylsiloxane, α-(2-hydroxyl-methacryloxypropyloxypropyl)-ω-butyldecamethylpentasiloxane, α-[3-(meth)acryloxyethoxy-2-hydroxypropyloxypropyl]-terminated ω-butyl (or ω-methyl) terminated polydimethylsiloxane, α-[3-(meth)acryloxy-propyloxy-2-hydroxypropyloxypropyl]-terminated ω-butyl (or ω-methyl) terminated polydimethylsiloxane, α-[3-(meth)acryloxyisopropyloxy-2-hydroxypropyloxypropyl]-terminated ω-butyl (or ω-methyl) terminated polydimethylsiloxane, α-[3-(meth)acryloxybutyloxy-2-hydroxypropyloxypropyl]-terminated ω-butyl (or ω-methyl) terminated polydimethylsiloxane, α-[3-(meth)acryloxyethylamino-2-hydroxypropyloxypropyl]-terminated ω-butyl (or ω-methyl) terminated polydimethylsiloxane, α-[3-(meth)acryloxypropylamino-2-hydroxypropyloxypropyl]-terminated ω-butyl (or ω-methyl) terminated polydimethylsiloxane, α-[3-(meth)acryloxy-butylamino-2-hydroxypropyloxypropyl]-terminated ω-butyl (or ω-methyl) terminated polydimethylsiloxane, α-(meth)acryloxy(polyethylenoxy)-2-hydroxypropyloxypropyl]-terminated ω-butyl (or ω-methyl) terminated polydimethylsiloxane, α-[(meth)acryloxy-2-hydroxypropyloxy-ethoxypropyl]-terminated ω-butyl (or ω-methyl) terminated polydimethylsiloxane, α-[(meth)acryloxy-2-hydroxypropyl-N-ethylaminopropyl]-terminated ω-butyl (or ω-methyl) terminated polydimethylsiloxane, α-[(meth)acryloxy-2-hydroxypropyl-aminopropyl]-terminated ω-butyl (or ω-methyl) terminated polydimethylsiloxane, α-[(meth)acryloxy-2-hydroxypropyloxy-(polyethylenoxy)propyl]-terminated ω-butyl (or ω-methyl) terminated polydimethylsiloxane, α-(meth)acryloylamidopropyloxypropyl terminated ω-butyl (or ω-methyl) terminated polydimethylsiloxane, α-N-methyl-(meth)acryloylamidopropyloxypropyl terminated ω-butyl (or ω-methyl) terminated polydimethylsiloxane, α-[3-(meth)acrylamidoethoxy-2-hydroxypropyloxypropyl]-terminated ω-butyl (or ω-methyl) polydimethylsiloxane, α-[3-(meth)acrylamidopropyloxy-2-hydroxypropyloxypropyl]-terminated ω-butyl (or ω-methyl) terminated polydimethylsiloxane, α-[3-(meth)acrylamidoisopropyloxy-2-hydroxypropyloxypropyl]-terminated ω-butyl (or ω-methyl) terminated polydimethylsiloxane, α-[3-(meth)acrylamido-butyloxy-2-hydroxypropyloxypropyl]-terminated ω-butyl (or ω-methyl) terminated polydimethylsiloxane, α-[3-(meth)acryloylamido-2-hydroxypropyloxypropyl]terminated ω-butyl (or ω-methyl) polydimethylsiloxane, α-[3-[N-methyl-(meth)acryloylamido]-2-hydroxypropyloxy-propyl]terminated ω-butyl (or ω-methyl) terminated polydimethylsiloxane, N-methyl-N′-(propyltetra(dimethylsiloxy)dimethylbutylsilane) (meth)acrylamide, N-(2,3-dihydroxypropane)-N′-(propyltetra(dimethylsiloxy)dimethylbutylsilane) (meth)acrylamide, (meth)acryloylamidopropyltetra(dimethylsiloxy)dimethylbutylsilane, mono-vinyl carbonate-terminated mono-alkylterminated polydimethylsiloxanes, mono-vinyl carbamate-terminated mono-alkyl-terminated polydimethylsiloxane, and combinations thereof. The above polysiloxanes vinylic monomers can be obtained from commercial suppliers (e.g., Shin-Etsu, Gelest, etc.) or prepared by reacting a hydroxyalkyl (meth)acrylate or (meth)acrylamide or a (meth)acryloxypolyethylene glycol with a mono-epoxypropyloxypropyl-terminated polydimethylsiloxane, by reacting glycidyl (meth)acrylate with a mono-carbinol-terminated polydimethylsiloxane, a mono-aminopropyl-terminated polydimethylsiloxane, or a monoethylaminopropyl-terminated polydimethylsiloxane, or by reacting isocyanatoethyl (meth)acrylate with a mono-carbinol-terminated polydimethylsiloxane according to coupling reactions.

In accordance with the disclosure, any polysiloxane vinylic crosslinkers can be used in in the formulation of the bulk silicone hydrogel material 106. Examples of polysiloxane vinylic crosslinkers include α,ω-(meth)acryloxy-terminated polydimethylsiloxanes of various molecular weight; α,ω-(meth)acrylamido-terminated polydimethylsiloxanes of various molecular weight; α,ω-vinyl carbonate-terminated polydimethylsiloxanes of various molecular weight; α,ω-vinyl carbamate terminated polydimethylsiloxane of various molecular weight; bis-3-methacryloxy-2-hydroxypropyloxypropyl polydimethylsiloxane of various molecular weight; N,N,N′,N′-tetrakis(3-methacryloxy-2-hydroxypropyl)-alpha,omega-bis-3-aminopropyl-polydimethylsiloxane of various molecular weight; the reaction products of glycidyl methacrylate with amino-functional polydimethylsiloxanes; the reaction products of an azlactone-containing vinylic monomer (any one of those described above) with hydroxyl-functional polydimethylsiloxanes, polysiloxanecontaining macromer selected from Macromer A, Macromer B, Macromer C, and Macromer D described in U.S. Pat. No. 5,760,100 (herein incorporated by reference in its entirety), or combinations thereof.

One class of polysiloxane vinylic crosslinkers are di-(meth)acryloyloxy terminated polysiloxane vinylic crosslinkers each having dimethylsiloxane units and hydrophilized siloxane units each having one methyl substituent and one monovalent C4-C40 organic radical substituent having 2 to 6 hydroxyl groups.

Another class of polysiloxane vinylic crosslinkers are vinylic crosslinkers each of which comprises one sole polysiloxane segment and two terminal (meth)acryloyl groups, which can be obtained from commercial suppliers; prepared by reacting glycidyl (meth)acrylate(meth)acryloyl chloride with a di-amino-terminated polydimethylsiloxane or a di-hydroxyl terminated polydimethylsiloxane; prepared by reacting isocyantoethyl (meth)acrylate with dihydroxyl-terminated polydimethylsiloxanes prepared by reacting an amino-containing acrylic monomer with di-carboxyl-terminated polydimethylsiloxane in the presence of a coupling agent (a carbodiimide); prepared by reacting a carboxyl-containing acrylic monomer with di-amino terminated polydimethylsiloxane in the presence of a coupling agent (a carbodiimide); or prepared by reacting a hydroxyl-containing acrylic monomer with a dihydroxy-terminated polydisiloxane in the presence of a diisocyanate or diepoxy coupling agent.

Other classes of polysiloxane vinylic crosslinkers are chain-extended polysiloxane vinylic crosslinkers each of which has at least two polysiloxane segments linked by a linker between each pair of polysiloxane segments and two terminal ethylenically unsaturated groups.

In at least some embodiments, the bulk silicone hydrogel material 106 additionally includes repeating units of at least one UV-absorbing vinylic monomer. Any UV-absorbing vinylic monomers can be used in the bulk silicone hydrogel material 106, so long as the UV-absorbing vinylic monomer can provide Class I UV protection. UV-absorbing vinylic monomers can be benzotriazole-containing vinylic monomers (i.e., ones each having a benzotriazole-moiety) and/or benzophenone containing vinylic monomers (i.e., ones each having a benzophenone-moiety). For example, at least one UV-absorbing vinylic monomer can be one or more benzotriazole-containing vinylic monomers (i.e., ones each having a benzotriazole-moiety) such as 2-(2′-hydroxy-5′-vinylphenyl)-2H-benzotriazole, 2-(2′-hydroxy-5′-methacryloxyphenyl)-2H-benzotriazole, 2-(2′-hydroxy-5′-acryloyloxyphenyl)-2H-benzotriazole, 2-[2′-hydroxy-5′-(2-methacryloxyethyl)phenyl)]-2H-benzotriazole (Norbloc), 2-[2′-hydroxy-5′-(2-acryloxyethyl)phenyl)]-2H-benzotriazole, 2-(2′-hydroxy-5′-methacryloxypropylphenyl)-2H-benzotriazole, 2-(2′-hydroxy-5′-acryloxypropylphenyl)-2H-benzotriazole, and combinations thereof. In some embodiments, at least one UV-absorbing vinylic monomer is 2-[2′-hydroxy-5′-(2-methacryloxyethyl)phenyl)]-2H-benzotriazole (Norbloc).

In at least some embodiments, the bulk silicone hydrogel material 106 additionally includes repeating units of at least one polymerizable HEVL-absorbing compound. In such embodiments, the polymerizable HEVL-absorbing compound is present in a small amount, as the HEVL-absorbing compound may compete with the monomeric optical brightener 108, absorbing or blocking the photons of UV light that activate the monomeric optical brighteners 108, reducing the amount of low contrast blue light produced and the overall benefit of the monomeric optical brightener 108. In at least some embodiments, the HEVL-absorbing compound may be present in an amount to provide a contact lens having about 65% or less absorbance of HEVL. Any polymerizable HEVL-absorbing compounds can be used in the bulk silicone hydrogel material 106 and/or in the layer of light absorbing chromophore 110. In at least some embodiments, the HEVL-absorbing compound can absorb HEVL between 380 nm and 450 nm. Polymerizable HEVL-absorbing compounds can be benzotriazole-containing vinylic monomers (i.e., ones each having a benzotriazole-moiety), benzophenone-containing vinylic monomers (i.e., ones each having a benzophenone-moiety), Cu(II)-porphyrin derivatives each having a Soret peak (i.e., an absorption peak in a region from 395 nm to 435 nm) invisible absorption spectrum, reactive yellow dyes, or combinations thereof. For example, HEVL-absorbing benzotriazole-containing vinylic monomers and/or Cu(II)-porphyrin derivatives are used in the bulk silicone hydrogel material 106. Examples of polymerizable HEVL-absorbing compounds include 2-{2′-Hydroxy-3′-tert-butyl-5′-[3′-methacryloyloxypropoxy]phenyl}-5-chloro-2H-benzotriazole (UV28) (having an HEVL absorption peak at 416 nm), 2-[2′-Hydroxy-3′-tert-butyl-5′-(3′-acryloyloxypropoxy)phenyl]-5-trifluoromethyl-2H-benzotriazole (UV23) (having an HEVL absorption peak at 418 nm), 2-{2′-Hydroxy-3′-tert-butyl-5′-[3′-methacryloyloxypropoxy]phenyl}-2H-benzotriazole (UV29), polymerizable Cu(II)-porphyrin derivatives, and combinations thereof. In at least some embodiments, a non-reactive or monomeric HEVL-absorbing compounds can be used in the bulk silicone hydrogel material 106 and/or in the layer of light absorbing chromophore 110. Non-reactive or monomeric HEVL-absorbing compounds can be benzotriazole-containing compounds, benzophenone-containing compounds, triazines-containing compounds, yellow dyes, for example tartrazine, or combinations thereof. Examples of non-reactive or monomeric HEVL-absorbing compounds include hydroxyphenyl benzotriazoles, 2-(2′hydroxy-3′-tert-butyl-5′-methylphenyl)-5-chlorobenzotriazole, 2-(2H-benzotriazol-2-yl)-4,6-ditertpentylphenol-2-phenol, 2-(2H-benzotriazol-2-yl)-4-(1,1,3,3-tetramethylbutyl), 2-hydroxy-4-n-octoxybenzophenone, 2,4-dihydroxybenzophenone, 2,2′,4,4′-tetrahydroxybenzophenone, 2-hydroxy-4-methoxybenzophenone, or combinations thereof.

In at least some embodiments, the bulk silicone hydrogel material 106 additionally includes at least one blue-tinting agent. Blue-tinting agents can provide visibility blue-tint to commercial contact lenses in order for a wearer to see a contact lens immersed in a solution while not changing the wearer's eye color. Examples of blue-tinting agents include Cu(II)-phthalocyanine pigment particles, polymerizable blue dyes, and combinations thereof. Examples of polymerizable blue dyes include 1,4-bis(4-(2-methacryloxyethyl)phenylamino) anthraquinone (Reactive Blue 246), 1,4-bis((2-methacryloxy-ethyl)amino)anthraquinone (Reactive Blue 247), and combinations thereof.

In accordance with the disclosure, the bulk silicone hydrogel material 106 can further include repeating units of at least one hydrophobic non-silicone vinylic monomer and/or at least one non-silicone vinylic crosslinker. Any suitable hydrophobic non-silicone vinylic monomers can be used for forming the bulk silicone hydrogel material 106 in combination with other polymerizable components. Examples of hydrophobic non-silicone vinylic monomers include methyl (meth)acrylate, ethyl (meth)acrylate, methoxyethyl (meth)acrylate, propyl (meth)acrylate, isopropyl (meth)acrylate, cyclohexyl (meth)acrylate, 2-ethylhexyl (meth)acrylate, isobornyl (meth)acrylate, (meth)acrylonitrile, etc.), 2,2,2-trifluoroethyl (meth)acrylate, tetrafluoropropyl (meth)acrylate, hexafluoro-iso-propyl (meth)acrylate, hexafluorobutyl (meth)acrylate, heptafluorobutyl (meth)acrylate, octafluoropentyl (meth)acrylate, heptadecafluorodecyl (meth)acrylate, pentafluorophenyl (meth)acrylate, vinyl acetate, vinyl propionate, vinyl butyrate, vinyl valerate, vinyl ethyl ether, propyl vinyl ether, n-butyl vinyl ether, isoputyl vinyl ether, cyclohexyl vinyl ether, t-butyl vinyl ether, styrene, vinyl toluene, vinyl chloride, vinylidene chloride, 1-butene, and combinations thereof.

Any suitable non-silicone vinylic crosslinkers can be used for forming the bulk silicone hydrogel material 106 in combination with other polymerizable components. Examples of non-silicone vinylic crosslinkers include ethylene glycol di(meth)acrylate; 1,3-propanediol di(meth)acrylate; 2,3-propanediol di(meth)acrylate; 1,3-butanediol di-(meth)acrylate;1,4-butanediol di(meth)acrylate; glycerol 1,3-diglycerolate di-(meth)acrylate; 1,5-pentanediol di(meth)acrylate; 1,6-hexanediol di(meth)acrylate; diethylene glycol di(meth)acrylate; triethylene glycol di(meth)acrylate; tetraethylene glycol di(meth)acrylate; ethylenebis[oxy(2-hydroxypropane-1,3-diyl)]di-(meth)acrylate; bis[2-(meth)acryloxyethyl]phosphate; 3,4-bis[(meth)acryloyl]tetrahydrofuan; di(meth)acrylamide; N,N-di(meth)acryloyl-Nmethylamine; N,N-di(meth)acryloyl-N-ethylamine; N,N′-methylene bis((meth)acrylamide); N,N′-ethylene bis((meth)acrylamide); N,N′-hexamethylene bis-(meth)acrylamide; N,N′-dihydroxyethylene bis(meth)acrylamide; N,N′-propylene bis-(meth)acrylamide; N,N′-2-hydroxypropylene bis(meth)acrylamide; N,N′-2,3-dihydroxy-butylene bis(meth)acrylamide; 1,3-bis(meth)acrylamidepropane-2-yl dihydrogen phosphate; piperazine diacrylamide; pentaerythritol tri(meth)acrylate; trimethyloylpropane tri(meth)acrylate; tris(2-hydroxyethyl)isocyanurate tri(meth)acrylate; 1,3,5-tri(meth)acryloxyl-hexahydro-1,3,5-triazine; pentaerythritol tetra(meth)acrylate; di(trimethyloylpropane) tetra(meth)acrylate; tetraethyleneglycol divinyl ether, triethyleneglycol divinyl ether, diethyleneglycol divinyl ether, ethyleneglycol divinyl ether, triallyl isocyanurate, triallyl cyanurate, allylmethacrylate, allylacrylate, N-allyl-methacrylamide, N-allyl-acrylamide, or combinations thereof.

In accordance with the disclosure, any thermal free-radical initiators can be used for forming the bulk silicone hydrogel material 106. Suitable thermal free-radical initiators include, for example, peroxides, hydroperoxides, azo-bis(alkyl- or cycloalkylnitriles), persulfates, percarbonates, or mixtures thereof. Examples of thermal free-radical initiators include benzoyl peroxide, t-butyl peroxide, t-amyl peroxybenzoate, 2,2-bis(tertbutylperoxy) butane, 1,1-bis(tert-butylperoxy)cyclohexane, 2,5-Bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, di-t-butyl-diperoxyphthalate, t-butyl hydroperoxide, t-butyl peracetate, t-butyl peroxybenzoate, t-butylperoxy isopropyl carbonate, acetyl peroxide, lauroyl peroxide, decanoyl peroxide, dicetyl peroxydicarbonate, di(4-t-butylcyclohexyl)peroxy dicarbonate (Perkadox 16S), di(2-ethylhexyl)peroxy dicarbonate, t-butylperoxy pivalate (Lupersol 11); t-butylperoxy-2-ethylhexanoate (Trigonox 21-C50), 2,4-pentanedione peroxide, dicumyl peroxide, peracetic acid, potassium persulfate, sodium persulfate, ammonium persulfate, 2,2′-azobis(4-methoxy-2,4-dimethylvaleronitrile) (VAZO 33), 2,2′-Azobis[2-(2-imidazolin-2-yl)propane]dihydrochloride (VAZO 44), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64 or AIBN), 2,2′-azobis-2-methylbutyronitrile (VAZO 67), 1,1-azobis(1-cyclohexanecarbonitrile) (VAZO 88); 2,2′-azobis(2-cyclopropylpropionitrile), 2,2′-azobis(methylisobutyrate), 4,4′-Azobis(4-cyanovaleric acid), and combinations thereof.

In accordance with the disclosure, any photoinitiators can be used for forming the bulk silicone hydrogel material 106 so long as the photoinitiator can generate free radicals for initiating polymerization reaction upon being irradiated with a visible light having a wavelength greater 440 nm. Examples of photoinitiators include benzoylphosphine photoinitiators, acyl germanium photoinitiators (i.e., germanium-based Type I photoinitiators as described in U.S. Pat. No. 7,605,190), acyltin photoinitiators (e.g., tetrakis(2,4,6-trimethylbenzoyl)stannane or others.

Examples of benzoylphosphine initiators include 2,4,6-trimethylbenzoyldiphenylphosphine oxide (TPO); 2,4,6-trimethylbenzoylethoxy-phenylphosphine oxide (TPO-L); bis(2,4,6-trimethylbenzoyl)phenylphosphine oxide (BAPO); bis-(2,6-dichlorobenzoyl)-4-N-propylphenyl-phosphine oxide; bis-(2,6-dichlorobenzoyl)-4-Nbutylphenylphosphine oxide; lithium phenyl(2,4,6-trimethylbenzoyl) phosphinate (LiTPO); and combinations thereof.

Examples of acyl germanium photoinitiators include Bis(4-methoxybenzoyl)diethylgermanium (BMBDE-Ge), dibenzoyldiethylgermanium (DBDE-Ge), tetrakis(2-ethylbenzoyl)-germanium (TEB-Ge), and combinations thereof.

Examples of leachable lubricants include mucin-like materials (e.g., polyglycolic acid) and noncrosslinkable hydrophilic polymers (i.e., without ethylenically unsaturated groups). Any hydrophilic polymers or copolymers without any ethylenically unsaturated groups can be used as leachable lubricants. Examples of noncrosslinkable hydrophilic polymers include polyvinyl alcohols (PVAs), polyamides, polyimides, polylactone, a homopolymer of a vinyl lactam, a copolymer of at least one vinyl lactam in the presence or in the absence of one or more hydrophilic vinylic comonomers, a homopolymer of acrylamide or methacrylamide, a copolymer of acrylamide or methacrylamide with one or more hydrophilic vinylic monomers, polyethylene oxide (i.e., polyethyleneglycol (PEG)), a polyoxyethylene derivative, poly-N—N-dimethylacrylamide, polyacrylic acid, poly 2 ethyl oxazoline, heparin polysaccharides, polysaccharides, and mixtures thereof. The weight-average molecular weight Mw of the noncrosslinkable hydrophilic polymer can be from 5,000 to 100,000.

Examples of leachable tear-stabilizing agents include phospholipids, monoglycerides, diglycerides, triglycerides, glycolipids, glyceroglycolipids, sphingolipids, sphingo-glycolipids, fatty alcohols, fatty acids, mineral oils, and mixtures thereof. For example, a tear stabilizing agent is a phospholipid, a monoglyceride, a diglyceride, a triglyceride, a glycolipid, a glyceroglycolipid, a sphingolipid, a sphingo-glycolipid, a fatty acid having 8 to 36 carbon atoms, a fatty alcohol having 8 to 36 carbon atoms, or a mixture thereof.

In accordance with the disclosure, a polymerizable composition of the bulk silicone hydrogel material 106 is a fluid composition, which can be a solution (i.e., one including non-reactive diluent-solvent), or a solventless blend (e.g., a fluid composition free of any non-reactive diluent-solvent).

Where a polymerizable composition of the bulk silicone hydrogel material 106 is a solution. The polymerizable composition can be prepared by dissolving all of the desirable components in any suitable solvent. Example of suitable solvents include, water, tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol nbutyl ether, dipropylene glycol n-butyl ether, tripropylene glycol n-butyl ether, propylene glycol phenyl ether dipropylene glycol dimetyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl, alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-propanol, t-amyl alcohol, isopropanol, 1-methyl-2-pyrrolidone, N,N-dimethylpropionamide, dimethyl formamide, dimethyl acetamide, dimethyl propionamide, N-methyl pyrrolidinone, and combinations thereof. In at least some embodiments, a polymerizable composition is a solution of all the desirable components in water, 1,2-propylene glycol, a polyethyleneglycol having a molecular weight of about 400 Daltons or less, or a combinations thereof.

Where a polymerizable composition of the bulk silicone hydrogel material 106 is a solventless blend, the polymerizable composition can be prepared by mixing all polymerizable components and other necessary component. A solventless polymerizable composition typically comprises at least one blending vinylic monomer as a reactive solvent for dissolving all other polymerizable components of the solventless polymerizable composition. In at least some embodiments, methyl methacrylate is used as a blending vinylic monomer in preparing a solventless polymerizable composition.

Numerous lens formulations for forming silicone hydrogel contact lenses have been described in numerous patents and patent applications published by the filing date of this application and have been used in producing commercial SiHy contact lenses. Examples of commercial SiHy contact lenses include, asmofilcon A, balafilcon A, comfilcon A, delefilcon A, efrofilcon A, enfilcon A, fanfilcon A, galyfilcon A, lotrafilcon A, lotrafilcon B, narafilcon A, narafilcon B, senofilcon A, senofilcon B, senofilcon C, smafilcon A, somofilcon A, and stenfilcon A. Any commercial SiHy contact lens formulation can be used as a base formulation for forming a polymerizable composition for forming a bulk silicone hydrogel material 106 of the present disclosure.

Any lens mold for making contact lenses including SiHy contact lenses, such as the contact lens 100, may be used, for example, lens molds that are employed in cast molding or spin casting. For example, a mold (for cast molding) generally comprises at least two mold sections (or portions) or mold halves, i.e., first and second mold halves. The first mold half defines a first molding (or optical) surface and the second mold half defines a second molding (or optical) surface. The first and second mold halves are configured to receive each other such that a lens-forming cavity is formed between the first molding surface and the second molding surface. The molding surface of a mold half is the cavity-forming surface of the mold and in direct contact with the polymerizable composition.

The mold halves can be formed through various techniques, such as injection molding. The process of the present disclosure is not limited to any particular method of forming a mold. In fact, any method of forming a mold can be used in the present disclosure. The mold halves can be formed through various techniques, such as injection molding or lathing.

Virtually all materials known in the art for making molds can be used to make molds for making contact lenses. For example, polymeric materials, such as polyethylene, polypropylene, polystyrene, polymethyl methacrylate (PMMA), Topas® COC grade 8007-S10 (clear amorphous copolymer of ethylene and norbornene, from Ticona GmbH of Frankfurt, Germany and Summit, New Jersey), or the like can be used. Other materials that allow UV light transmission could be used, such as quartz glass and sapphire.

In accordance with the disclosure, a polymerizable composition can be introduced (dispensed) into a cavity formed by a mold according to any known methods.

In at least some embodiments, the polymerizable composition includes the monomeric optical brightener 108. The monomeric optical brightener 108 is a non-reactive optical brightener that is not incorporated into the polymer(s) formed by the polymerizable composition. Dispensing the optical brightener with the polymerizable composition ensures that the optical brightener is evenly dispersed/incorporated throughout the bulk silicone hydrogel material 106 formed from the polymerizable composition. Advantageously, including the monomeric optical brightener 108 in the dispensed polymerizable composition can provide higher concentrations of the monomeric optical brightener 108 in the middle of the bulk silicone hydrogel material 106 and a more even distribution of the monomeric optical brightener 108 in the contact lens 100 than what may be achieved by soaking a preformed contact lens in a solution of the monomeric optical brightener 108. The distribution of optical brightener 108 in the bulk silicone hydrogel material 106 can be determined by exposing the lens to UV light and observing/measuring the corresponding blue glow. A large inhomogeneity would be easily visible and, if necessary, an objective measure of local brightness can be determined.

After the polymerizable composition is dispensed into the mold, the polymerizable composition is polymerized to produce a contact lens. Crosslinking may be initiated thermally or actinically to crosslink the polymerizable components in the polymerizable composition.

The thermal polymerization is carried out conveniently, for example, at a temperature of from about 25° C. to about 120° C., such as about 40° C. to about 100° C. The reaction time may vary within wide limits, but is conveniently, for example, from about 30 minutes to about 4 hours or from about 1 to about 2 hours. It is advantageous to previously degas the components and solvents used in the polymerization reaction and to carry out said copolymerization reaction under an inert atmosphere, for example under a nitrogen or argon atmosphere.

The actinic polymerization can then be triggered off by actinic radiation, for example, a visible light of a suitable wavelength.

After the curing step, the steps of opening a mold (i.e., separating the male mold half from the female mold half with the contact lens attached onto one of the male and female mold halves and delensing (i.e., removing the contact lens from the lens adhered mold half) are carried out according to any suitable techniques.

After the molded contact lens is delensed, the contact lens typically is extracted with an extraction medium. The extraction liquid medium is any solvent capable of dissolving the diluent(s), unpolymerized polymerizable materials, and oligomers in the lens precursor. Water, any organic solvents described above, or a mixture thereof can be used to extract the contact lens.

The extracted contact lens can be further subject to surface treatment to form a coating on the surfaces of the preformed contact lenses. The contact lenses then can be packaged and autoclaved (at from 118° C. to 124° C. for at least about 30 minutes) in sealed lens packages with a packaging solution.

In at least some embodiments, one or more chromophore may be pad printed or otherwise disposed on the contact lens. The process of the present disclosure is not limited to any particular method of pad printing. In fact, any method of pad printing can be used in the present disclosure. In at least some embodiments, the monomeric optical brightener 108 is pad printed on the posterior side of the contact lens. In at least some embodiments, a light absorbing chromophore, such as a blue light absorbing chromophore is pad printed on the anterior side of the contact lens.

Lens packages (or containers) are used for autoclaving and storing a soft contact lens. Any lens packages can be used. In at least some embodiments, a lens package is a blister package which comprises a base and a cover, wherein the cover is detachably sealed to the base, wherein the base includes a cavity for receiving a sterile packaging solution and the contact lens.

Lenses are packaged in individual packages, sealed, and sterilized (e.g., by autoclave at about 120° C. or higher for at least 30 minutes under pressure) prior to dispensing to users.

In at least some embodiments, the contact lens 100 is an embedded contact lens having an insert layer including the light absorbing chromophore 110 embedded at the anterior surface 102 of the contact lens 100. In at least some embodiments, the embedded contact lens may be molded in a mold assembly having three mold halves, a female lens mold half, a male insert mold half, and a male lens mold half. The female lens mold half has a first molding surface defining the anterior surface of a contact lens to be molded, the male insert mold half has a second molding surface defining the back surface of an insert to be molded, and the male lens mold half has a third molding surface defining the posterior surface of the contact lens to be molded. The male insert mold half and the female lens mold half are configured to receive each other such that an insert-molding cavity is formed between the second molding surface and a central portion of the first molding surface when the female lens mold half is closed with the male insert mold half. The male lens mold half and the female lens mold half are configured to receive each other such that a lens-molding cavity is formed between the first and third molding surfaces when the female lens mold half is closed with the male lens mold half.

In at least some embodiments, a light absorbing chromophore 110, such as a polymerizable HEVL-absorbing compound, is dispensed into the female lens mold half and the male insert mold half is closed over the female mold half. The light absorbing chromophore 110 may be thermally cured within the insert-molding cavity to form an insert layer. For example, the light absorbing chromophore 110 may be thermally cured at a temperature of from about 25° C. to about 120° C., such as about 40° C. to about 100° C., for about 30 minutes to about 4 hours. The male insert mold half is removed leaving the insert layer adhered onto the central portion of the first molding surface. The polymerizable composition of the contact lens 100 may then be dispensed into the female lens mold half over the insert layer adhered onto the central portion of the first molding surface and the male lens mold half may be closed over the female mold half. In at least some embodiments, the polymerizable composition is cured as described above to form an embedded contact lens that may be delensed, processed, and packaged as described above.

Various embodiments of polymerizable compositions, hydrophilic vinylic monomers, silicone-containing vinylic monomers, polysiloxane vinylic crosslinkers, UV absorbing vinylic monomers, polymerizable HEVL-absorbing compounds, blue tinting agents, non-silicone hydrophobic vinylic monomers, non-silicone vinylic crosslinkers, free-radical initiators, molds, thermal curing, photocuring, demolding, delensing, extraction, hydration, surface treatment, packaging, and autoclaving have been described above and can be used in these aspects of the disclosure.

### Embodiments

The present disclosure is further directed to the following embodiments, which may be combined with any embodiments described herein.

Clause 1. A contact lens treating myopia progression, comprising: a bulk silicone hydrogel material that comprises; repeating units of at least one hydrophilic vinylic monomer; and repeating units of at least one silicone-containing vinylic monomer, at least one polysiloxane vinylic crosslinker, or combinations thereof, and a monomeric optical brightener disposed throughout the bulk silicone hydrogel material.

Clause 2. The contact lens of clause 1, wherein the monomeric optical brightener is evenly distributed between an anterior surface of the contact lens and a posterior surface of the contact lens.

Clause 3. The contact lens of clause 1 or 2, wherein the monomeric optical brightener absorbs ultraviolet (UV) light and fluoresce a blue light.

Clause 4. The contact lens of clause 1 to 3, wherein the blue light fluoresced by the monomeric optical brightener is de-focused blue light.

Clause 5. The contact lens of clause 1 to 4, wherein the contact lens provides blue light having a lower contrast than red light or green light provided by the contact lens.

Clause 6. The contact lens of clause 1 to 5, wherein the monomeric optical brightener absorbs light having a wavelength of about 370 nm to about 420 nm and re-emits light having a wavelength of about 420 nm to about 470 nm.

Clause 7. The contact lens of clause 1 to 6, wherein the monomeric optical brightener comprises stilbenes, oxazoles, derivatives thereof, or combinations thereof.

Clause 8. The contact lens of clause 1 to 7, wherein the monomeric optical brightener comprises bis(benzoxazol-2-yl) derivatives, distyrylbenzenes, distyrylbiphenyls, divinylstilbenes, triazinylaminostilbenes, stilbenyl-2H-triazoles, benzofurans, benzimidazoles, diphenyl pyrazolines, coumarins, naphthalimides, or combinations thereof.

Clause 9. The contact lens of clause 1 or 8, wherein the monomeric optical brightener comprises 4,4′-diamino-2,2′-stilbenedisulfonic acid, 2,2′-(1,4-naphthalenediyl)bisbenzoxazole, 2,5-thiophenediylbis(5-tert-butyl-1,3-benzoxazole), 4,4′-bis(2-benzoxazolyl)stilbene, disodium-4,4′-bis(2-sulfonatostyryl)-biphenyl, or combinations thereof.

Clause 10. The contact lens of clause 1 or 9, wherein the monomeric optical brightener comprises 2,5-thiophenediylbis(5-tert-butyl-1,3-benzoxazole), 4 4′-bis(2-benzoxazolyl)stilbene, disodium-4,4′-bis(2-sulfonatostyryl)biphenyl, or combinations thereof.

Clause 11. The contact lens of clause 1 or 10, wherein the at least one hydrophilic vinylic monomer comprises hydroxyethyl(meth)acrylate, glycerol (meth)acrylate, N-2-hydroxylethyl (meth)acrylamide, N,Nbis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, di(ethylene glycol) (meth)acrylate, tri(ethylene glycol) (meth)acrylate, tetra(ethylene glycol) (meth)acrylate, poly(ethylene glycol) (meth)acrylate, N,N-dimethyl (meth)acrylamide, (meth)acrylamide, N-ethyl (meth)acrylamide, N,N-diethyl (meth)acrylamide, N-propyl (meth)acrylamide, N-isopropyl (meth)acrylamide, N-3-methoxy-propyl (meth)acrylamide, N-vinylpyrrolidone, N-vinyl-N-methyl acetamide, N-vinyl-N-ethyl acetamide, N-vinyl-N-ethyl formamide, 1-methyl-3-methylene-2-pyrrolidone, 1-methyl-5-methylene-2-pyrrolidone, 1-methyl-3-methylene-2-pyrrolidone, N-2-hydroxyethyl vinyl carbamate, N-carboxyvinyl-β-alanine (VINAL), N-carboxyvinyl-α-alanine, a phosphorylcholine-containing vinylic monomer, (meth)acrylic acid, vinyl alcohol, ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, poly(ethylene glycol) methyl ether, or combinations thereof.

Clause 12. The contact lens of clause 1 or 11, wherein the bulk silicone hydrogel material comprises repeating units of at least one siloxane-containing vinylic monomer which is a siloxane-containing vinylic monomer having a bis(trialkylsilyloxy)-alkylsilyl group or a tris(trialkylsilyloxy)silyl group, a polysiloxane vinylic monomer, 3-methacryloxy propylpentamethyldisiloxane, tbutyldimethyl-siloxyethyl vinyl carbonate, trimethylsilylethyl vinyl carbonate, and trimethylsilylmethyl vinyl carbonate, or combinations thereof.

Clause 13. The contact lens of clause 1 or 12, wherein the bulk silicone hydrogel material comprises repeating units of at least one polysiloxane vinylic crosslinker.

Clause 14. The contact lens of clause 13, wherein the at least one polysiloxane vinylic crosslinker comprises a vinylic crosslinker having one sole polysiloxane segment and two ethyleneically unsaturated groups.

Clause 15. The contact lens of clause 13, wherein the at least one polysiloxane vinylic crosslinker comprises a chain-extended polysiloxane vinylic crosslinker having at least two polysiloxane segments linked by a linker between each pair of polysiloxane segments and two terminal ethylenically unsaturated groups.

Clause 16. The contact lens of clause 13, wherein the at least one polysiloxane vinylic crosslinker comprises a di-(meth)acryloyloxy-terminated polysiloxane vinylic crosslinker having dimethylsiloxane units and hydrophilized siloxane units each having one methyl substituent and one monovalent C₄-C₄₀ organic radical substituent having 2 to 6 hydroxyl groups.

Clause 17. An anti-myopiagenic contact lens, comprising: a bulk silicone hydrogel material comprising; a monomeric optical brightener disposed throughout the bulk silicone hydrogel material, the monomeric optical brightener comprising a stilbene, an oxazole, or combinations thereof, and a light absorbing chromophore disposed over an anterior surface of the bulk silicone hydrogel material.

Clause 18. The contact lens of clause 17, wherein the light absorbing chromophore absorbs blue light having a wavelength of about 450 nm and transmits blue light having a wavelength of about 380 nm to about 400 nm.

Clause 19. The contact lens of clause 17 and 18, wherein the monomeric optical brightener is evenly distributed between an anterior surface of the contact lens and a posterior surface of the contact lens.

Clause 20. The contact lens of clause 17 to 19, wherein the monomeric optical brightener absorbs ultraviolet (UV) light and fluoresce a blue light.

Clause 21. The contact lens of clause 17 to 20, wherein the blue light fluoresced by the monomeric optical brightener is low contrast blue light.

Clause 22. The contact lens of clause 17 to 21, wherein the light absorbing chromophore blocks outward anterior transmission of the blue light fluoresced by the monomeric optical brightener.

Clause 23. A contact lens comprising: a bulk silicone hydrogel material that comprises; repeating units of at least one hydrophilic vinylic monomer; and repeating units of at least one silicone-containing vinylic monomer, at least one polysiloxane vinylic crosslinker or combinations thereof; a monomeric optical brightener disposed on a posterior surface of the bulk silicone hydrogel material; and a light absorbing chromophore disposed over an anterior surface of the bulk silicone hydrogel material.

Clause 24. The contact lens of clause 23, wherein the monomeric optical brightener is disposed within an optical region of the contact lens.

Clause 25. The contact lens of clause 23 and 24, wherein the monomeric optical brightener absorbs ultraviolet (UV) light and fluoresce a blue light.

Clause 26. The contact lens of clause 23 to 25, wherein the blue light fluoresced by the monomeric optical brightener is low contrast blue light.

Clause 27. The contact lens of clause 23 to 26, wherein the light absorbing chromophore absorbs blue light having a wavelength of about 450 nm and transmits blue light having a wavelength of about 380 nm to about 400 nm.

Clause 28. The contact lens of clause 23 to 27, wherein the light absorbing chromophore is a high-energy visible light (HEVL) absorbing chromophore.

Overall, the present disclosure provides contact lenses that produce low contrast blue light with little or no reduction in contrast for red and green light. The low contrast blue light creates a large difference in focal distance and overall signal between the green and red cones and the cones responsible for blue light, stunting lens growth signaling in the brain and thus preventing development of myopia in children. In at least some embodiments, the optical brightener is a monomeric optical brightener suspended in the polymer matrix that forms the contact lens. In other embodiments, the optical brightener is printed as a layer on the posterior side of the contact lens.

Although various embodiments of the disclosure have been described using specific terms, devices, and methods, such descriptions are for illustrative purposes only. The words used are words of description rather than of limitation. It is to be understood that changes and variations may be made by those skilled in the art without departing from the spirit or scope of the present disclosure, which is set forth in the following claims. In addition, it should be understood that aspects of the various embodiments may be interchanged either in whole or in part. Therefore, the spirit and scope of the appended claims should not be limited to the description of the preferred versions contained therein.

Some implementations and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Some lower limits, upper limits and ranges appear in one or more claims below.

What is claimed is:

1. A contact lens for treating myopia progression, comprising:
a bulk silicone hydrogel material comprising:
repeating units of at least one hydrophilic vinylic monomer; and
repeating units of at least one silicone-containing vinylic monomer, at least one polysiloxane vinylic crosslinker, or combinations thereof, and
a monomeric optical brightener disposed throughout the bulk silicone hydrogel material.

2. The contact lens of claim 1, wherein the monomeric optical brightener is evenly distributed between an anterior surface of the contact lens and a posterior surface of the contact lens.

3. The contact lens of claim 1, wherein the monomeric optical brightener absorbs ultraviolet (UV) light and fluoresces a blue light.

4. The contact lens of claim 3, wherein the blue light fluoresced by the monomeric optical brightener is a de-focused blue light.

5. The contact lens of claim 1, wherein the contact lens provides blue light having a lower contrast than red light or green light provided by the contact lens.

6. The contact lens of claim 1, wherein the monomeric optical brightener absorbs light having a first wavelength of about 370 nm to about 420 nm and emits light having a second wavelength of about 420 nm to about 470 nm.

7. The contact lens of claim 1, wherein the monomeric optical brightener is selected from the group consisting of a stilbene, an oxazole, derivatives thereof, and combinations thereof.

8. The contact lens of claim 1, wherein the monomeric optical brightener is selected from the group consisting of 4,4′-diamino-2,2′-stilbenedisulfonic acid, 2,2′-(1,4-naphthalenediyl)bisbenzoxazole, 2,5-thiophenediylbis(5-tert-butyl-1,3-benzoxazole), 4,4′-bis(2-benzoxazolyl)stilbene, disodium-4,4′-bis(2-sulfonatostyryl)-biphenyl, and combinations thereof.

9. An anti-myopiagenic contact lens comprising:
a bulk silicone hydrogel material;
a monomeric optical brightener disposed substantially throughout the bulk silicone hydrogel material, the monomeric optical brightener selected from the group consisting of a stilbene, an oxazole, and combinations thereof, and
a light absorbing chromophore disposed over an anterior surface of the bulk silicone hydrogel material.

10. The anti-myopiagenic contact lens of claim 9, wherein the light absorbing chromophore absorbs blue light having a first wavelength of about 380 nm to about 420 nm and transmits blue light having a second wavelength of about 420 nm to about 460.

11. The anti-myopiagenic contact lens of claim 9, wherein the monomeric optical brightener is evenly distributed between an anterior surface of the contact lens and a posterior surface of the contact lens.

12. The anti-myopiagenic contact lens of claim 9, wherein the monomeric optical brightener absorbs ultraviolet (UV) light and fluoresces a blue light.

13. The anti-myopiagenic contact lens of claim 12, wherein the blue light fluoresced by the monomeric optical brightener is a de-focused blue light.

14. The anti-myopiagenic contact lens of claim 12, wherein the light absorbing chromophore blocks outward anterior transmission of the blue light fluoresced by the monomeric optical brightener.

15. A contact lens comprising:
a bulk silicone hydrogel material comprising:
repeating units of at least one hydrophilic vinylic monomer; and
repeating units of at least one silicone-containing vinylic monomer, at least one polysiloxane vinylic crosslinker, or combinations thereof,
a monomeric optical brightener disposed on a posterior surface of the bulk silicone hydrogel material; and
a light absorbing chromophore disposed over an anterior surface of the bulk silicone hydrogel material.

16. The contact lens of claim 15, wherein the monomeric optical brightener is disposed at an optical region of the contact lens.

17. The contact lens of claim 15, wherein the monomeric optical brightener absorbs ultraviolet (UV) light and fluoresces a blue light.

18. The contact lens of claim 17, wherein the blue light fluoresced by the monomeric optical brightener is de-focused blue light.

19. The contact lens of claim 15, wherein the light absorbing chromophore absorbs blue light having a first wavelength of about 380 nm to about 420 nm and transmits blue light having a second wavelength of about 420 nm to about 460.

20. The contact lens of claim 15, wherein the light absorbing chromophore is a high-energy visible light (HEVL) absorbing chromophore.
